(19) United States
(12) Patent Application Publication
(10) Pub. No.: US 2023/0251114 A1
(43) Pub. Date: Aug. 10, 2023

(54) Single Track Optical Encoder

(71) Applicant: Apple Inc., Cupertino, CA (US)

(72) Inventors: David D. Dashevsky, San Jose, CA (US); Christopher Gardiner, San Francisco, CA (US); Tingjun Xu, San Jose, CA (US)

(21) Appl. No.: 17/668,290

(22) Filed: Feb. 9, 2022

(51) Int. Cl. G01D 13/04

(52) U.S. Cl. CPC G01D 13/04

(57) ABSTRACT

A method includes imaging, with an optical read head attached to a second mechanical component, a portion of an encoder track disposed on a first mechanical component. The encoder track has a first encoder scale extending along the encoder track and a second encoder scale extending along the encoder track, and the imaged portion of the encoder track includes a first portion of the first encoder scale and a second portion of the second encoder scale. The method further includes transforming an imaged portion of the encoder track to a spatial frequency domain; identifying a pair of frequency bins in the spatial frequency domain; determining a phase difference between a first frequency bin and a second frequency bin in the pair of frequency bins; and mapping the phase difference to a positional relationship between the first mechanical component and the second mechanical component.

### FIELD

The described embodiments relate generally to optical encoders and to devices that include optical encoders. More particularly, the described embodiments relate to absolute optical encoders having a single track with two or more encoder scales.

### BACKGROUND

Sensor systems are included in many of today's electronic devices, including electronic devices such as smartphones, computers (e.g., tablet computers or laptop computers), wearable electronic devices (e.g., electronic watches or health monitors), game controllers, navigation systems (e.g., vehicle navigation systems or robot navigation systems), robots, motor vehicles, and so on. Sensor systems may variously sense the presence of objects, distances to objects or proximities of objects, movements of objects (e.g., whether objects are moving, or the speed, acceleration, or direction of movement of objects), positions of objects, and so on.

Given the wide range of sensor system applications, any new development in the configuration or operation of a sensor system can be useful. New developments that may be particularly useful are developments that reduce the cost, size, complexity, part count, or manufacture time of the sensor system, or developments that improve the sensitivity, accuracy, or speed of sensor system operation.

### SUMMARY

Embodiments of the systems, devices, methods, and apparatus described in the present disclosure are directed to optical encoders that use an optical read head to read a single encoder track that includes more than one encoder scale.

In a first aspect, the present disclosure describes an electronic device. The electronic device may include a first mechanical component and a second mechanical component. The first mechanical component or the second mechanical component is operable to be moved to change a positional relationship between the first mechanical component and the second mechanical component. The electronic device may also include an encoder track on the first mechanical component. The encoder track may include a first encoder scale extending along the encoder track, and a second encoder scale extending along the encoder track. The first encoder scale may have a first period different from a second period of the second encoder scale. An optical read head may be attached to the second mechanical component and have multiple pixels extending along a portion of the encoder track, and a field of view including a first portion of the first encoder scale and a second portion of the second encoder scale. Relative movement between the first and second mechanical components may cause relative movement of the field of view of the optical read head along the encoder track.

In a second aspect, the present disclosure describes a method of determining a position of a first mechanical component with respect to a second mechanical component. The method may include imaging, with an optical read head attached to the second mechanical component, a portion of an encoder track disposed on the first mechanical component. The encoder track may have a first encoder scale extending along the encoder track and a second encoder scale extending along the encoder track, and the imaged portion of the encoder track may include a first portion of the first encoder scale and a second portion of the second encoder scale. The method may further include transforming an imaged portion of the encoder track to a spatial frequency domain; identifying a pair of frequency bins in the spatial frequency domain; determining a phase difference between a first frequency bin and a second frequency bin in the pair of frequency bins; and mapping the phase difference to a positional relationship between the first mechanical component and the second mechanical component.

In a third aspect, the present disclosure describes another electronic device. The electronic device may include a first mechanical component; a second mechanical component, movably coupled to the first mechanical component; an encoder track on the first mechanical component, the encoder track including an encoder scale comprising a set of two-dimensional (2D) sinusoids extending along a length of the encoder track; and an optical read head attached to the second mechanical component. The optical read head may have a field of view including a portion of the encoder scale, and relative movement between the first and second mechanical components may cause relative movement of the field of view of the optical read head along the encoder track.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example structure including first and second mechanical components connected by a rotary joint;

FIG. 2 shows an example of a device having a crown and/or a button;

FIG. 3 shows an example plan view of an optical encoder including an encoder track and an optical read head, in which the encoder track has a circular path;

FIG. 4 shows an example perspective view of an optical encoder including an encoder track and an optical read head, in which the encoder track has a cylindrical path;

FIG. 5 shows an example plan view of an optical encoder including an encoder track and an optical read head, in which the encoder track is linear;

FIG. 6 shows a first example portion of an encoder track;

FIG. 7 shows an example output of the optical read head shown in FIG. 6;

FIG. 8 shows an example Fourier transform of the optical read head output shown in FIG. 7;

FIG. 9 shows an example method of determining an absolute position of a first mechanical component with respect to a second mechanical component;

FIG. 10 shows a second example portion of an encoder track; and

FIG. 11 shows a sample electrical block diagram of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

A conventional incremental optical encoder may include a sensor module that reads an encoder scale disposed on a linear, disc-shaped, or cylindrical encoder track, and outputs a change in linear or angular position between an optical read head and the encoder scale. Additionally or alternatively, the sensor module may output a count or other indication after a preset change in linear or angular position between the optical read head and the encoder scale. An incremental optical encoder cannot determine an unambiguous linear or angular position between an optical read head and encoder scale, absent relative movement between the optical read head and encoder scale during a calibration or “zeroing” procedure.

In contrast to a conventional incremental optical encoder, a conventional absolute optical encoder may include a sensor module that reads an unambiguous linear or angular position from an encoder scale. For example, in a rotary optical encoder, where one full rotation is represented by 0-360 degrees, an absolute optical encoder may output a specific angular position between 0-360 degrees. The resolution of the determined position may depend on the granularity of one or more encoder scales, the type of optical read head(s) that is/are used to read the encoder scales(s), and so on.

Absolute optical encoders can be subdivided into static absolute optical encoders and micro-motion absolute optical encoders. A static absolute optical encoder includes a sensor module that reads an encoder scale and indicates an unambiguous linear or angular position between an optical read head and an encoder scale regardless of whether there is any movement between the optical read head and encoder scale. In contrast, a micro-motion absolute optical encoder requires a nominal amount of movement between an optical read head and an encoder scale before an unambiguous linear or angular position can be determined.

Among absolute optical encoders, the two major types are digital optical encoders and Nonius optical encoders. Digital optical encoders read a (typically) binary code of light and dark areas representing 0s and 1s. Classically, each bit of the code required its own encoder track, and a line of optical read heads oriented perpendicularly to the direction of travel of the encoder tracks would read a sequence of bits oriented perpendicular to the encoder tracks. An 8-bit encoder (256 unique positions) would require 8 encoder tracks, each encoding one bit of information. More recently, digital optical encoders have advanced to a single track variety, using a shift register and/or cyclical code structures, such as a pseudo-random binary sequence (PRBS). In these more recent implementations, an optical read head is oriented along the direction of travel of a single encoder track, and each movement of the encoder track beyond a threshold amount represents a shift in a shift register. Each state of the shift register is unique. This latter approach replaces N encoder tracks with one encoder track.

The other type of absolute optical encoder is the Nonius optical encoder. A Nonius optical encoder is ordinarily an analog optical encoder composed of two encoder tracks. The first encoder track has N light-dark cycles extending from the beginning to the end of a linear or rotary encoder scale. The second encoder track has N−1 light-dark cycles. A different optical read head reads each encoder scale and measures a respective phase, which phase represents an ambiguous location along one of the encoder tracks (for example, it can be determined whether an optical read head is halfway between a light-dark line pair, but it cannot be determined which line pair among the N line pairs the optical read head is reading). However, the phase difference between the two optical read heads can be mapped to a unique linear or angular position.

The following description relates to a single track optical encoder, which in some embodiments may be a static absolute optical encoder. The following description also relates to an optical phase encoder, similar to a Nonius encoder. For purposes of this description, an optical phase encoder is defined to be an optical encoder that reads two or more encoder scales and determines a phase mismatch between portions of the encoder scales within a field of view of an optical read head. The phase mismatch may be mapped to a unique linear or angular position between two mechanical components. The described encoders differ from conventional Nonius optical encoders, in some respects, in that they include an optical read head that reads two or more encoder scales.

In a conventional optical phase encoder, each encoder scale is on a separate encoder track and is read by a separate optical read head. In at least some of the described embodiments, an optical read head may read two or more encoder scales on a single encoder track (i.e., a “single track”), and spatial frequency division multiplexing and demultiplexing may be used to determine a phase mismatch between imaged portions of the two or more encoder scales. In this manner, fewer optical read heads can be used and/or thinner encoder scales can be used, thereby reducing the size, weight, and/or cost of an optical encoder in comparison to conventional optical encoders. Also, compared to a single track digital optical encoder, a higher encoder resolution can be obtained for the same number of optical read head pixels. For example, an 8-pixel PRBS-based digital optical encoder has 256 states, while an 8-pixel single track optical phase encoder, having the same or similar dimensions, can encode 5000 or more states.

Micro-motion is not necessary for the optical encoders described below to determine a linear or angular position. This can simplify many mechanical or robotic applications. For example, motor commutation can be accomplished without more complex control algorithms like pinging to phase. Micro-motion is often required for digital optical encoders, in order to guarantee that the optical read head is not positioned between code blocks.

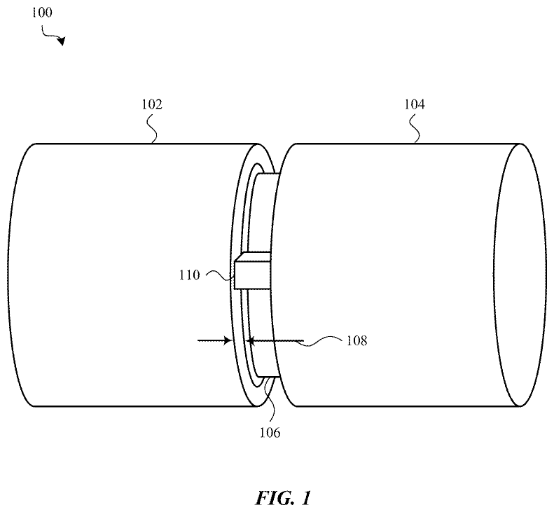

These and other embodiments and advantages are discussed with reference to FIGS. 1-11. However, those skilled in the art will readily appreciate that the detailed description given herein with respect to these figures is for explanatory purposes only and should not be construed as limiting.

Directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. The use of alternative terminology, such as “or”, is intended to indicate different combinations of the alternative elements. For example, A or B is intended to include A, or B, or A and B.

FIG. 1 shows an example structure 100 including first and second mechanical components 102, 104 connected by a rotary joint 106. Although the first and second mechanical components 102, 104 are referred to as “mechanical” components, the first and second mechanical components 102, 104 may carry circuitry, sub-components, or other elements for performing mechanical, electrical, optical, or other types of functions.

The first mechanical component 102 and/or the second mechanical component 104 may be operable to be moved, to change a positional relationship between the first mechanical component 102 and the second mechanical component 104 (i.e., the first and second mechanical components 102, 104 may be movably coupled to one another). More particularly, the first and/or second mechanical component 102, 104 may be operable to be rotated about the rotary joint 106, or rotated with respect to the other one of the first or second mechanical component 102, 104, to change a positional relationship between the first and second mechanical component 102, 104. In some embodiments, the first and second mechanical components 102, 104 may represent portions of a robotic arm, a fixed member and a rotating member of a drive shaft or propeller shaft, part of a housing and input member (e.g., a rotatable knob or crown), and so on.

An encoder track 108 may be disposed on the first mechanical component 102. An optical read head 110 may be attached to the second mechanical component 104. Relative movement between the first and second mechanical components 102, 104 causes relative movement of the field of view of the optical read head 110 along the encoder track 108 (i.e., along a direction of travel of the optical read head 110 along the encoder track 108).

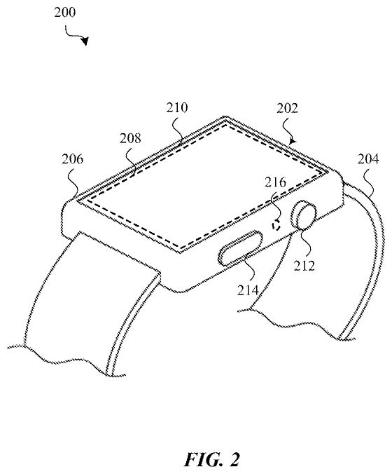

FIG. 2 shows an example of a device 200 having a crown 212 and/or a button 214. The device's dimensions and form factor, and inclusion of a band 204, suggest that the device 200 is an electronic watch. However, the device 200 could alternatively be any wearable electronic device. The device 200 may include a body 202 (e.g., a watch body) and a band 204. The watch body 202 may include an input or selection device, such as a crown 212 or a button 214. The band 204 may be used to attach the body 202 to a body part (e.g., an arm, wrist, leg, ankle, or waist) of a user. The body 202 may include a housing 206 that at least partially surrounds a display 208. The housing 206 may include or support a front cover 210 or a rear cover (not shown). The front cover 210 may be positioned over the display 208, and may provide a window through which the display 208 may be viewed. In some embodiments, the display 208 may be attached to (or abut) the housing 206 and/or the front cover 210. In alternative embodiments of the device 200, the display 208 may not be included and/or the housing 206 may have an alternative configuration.

The device 200 may include various sensor systems, such as a touch sensor system, a force sensor system, an ambient light sensor, a proximity sensor, and so on. In some embodiments, the device 200 may have a port 216 (or set of ports) on a side of the housing 206 (or elsewhere), and an ambient pressure sensor, ambient temperature sensor, internal/external differential pressure sensor, gas sensor, particulate matter concentration sensor, or air quality sensor may be positioned in or near the port(s) 216.

The crown 212 may in some embodiments be rotated and/or pushed to provide input to the device 200. An external portion of the crown 212 may be coupled to a shaft that rotates within the device 200. An encoder track may be disposed on a cylindrical surface of the internal shaft or external portion of the crown 212, and an optical read head may be positioned to read the encoder track as the crown 212 is moved. Alternatively, a back surface of the crown 212 or end of the internal surface may have a planar encoder track disposed thereon, and an optical read head may be positioned to read the planar encoder track.

Similarly to the crown 212, the button 214 may in some embodiments be pushed (and actually move) to provide input to the device 200. To read the push input, an encoder track may be disposed on a surface of the crown 212 or button 214, and an optical read head may be positioned to read the encoder track as it translates with respect to an axis of the crown 212 or button 214.

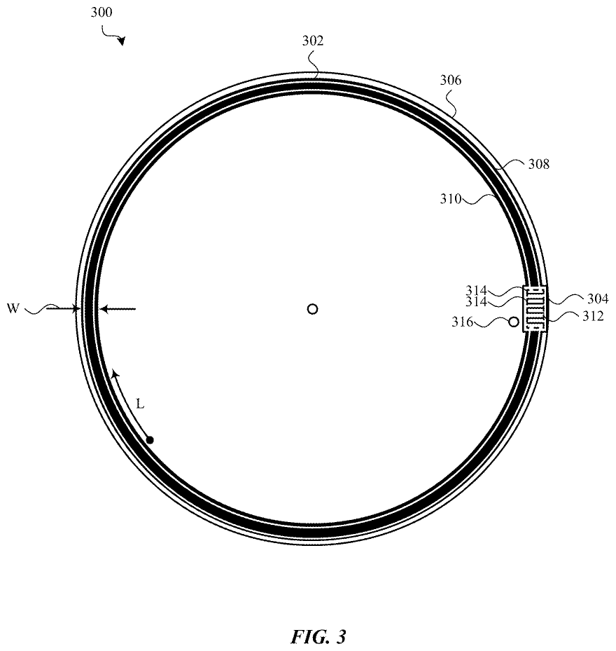

FIG. 3 shows an example plan view of an optical encoder 300 including an encoder track 302 and an optical read head 304. The encoder track 302 may be disposed on a planar surface 306 and have a circular path. In some embodiments, the planar surface 306 may be a surface of a first mechanical component, such as a surface of the first mechanical component described with reference to FIG. 1 or a surface (e.g., an end or a peripheral ledge) of the crown described with reference to FIG. 2. The optical read head 304 may be attached to a second mechanical component, such as the second mechanical component described with reference to FIG. 1, or a housing, frame, or other component positioned near the crown described with reference to FIG. 2.

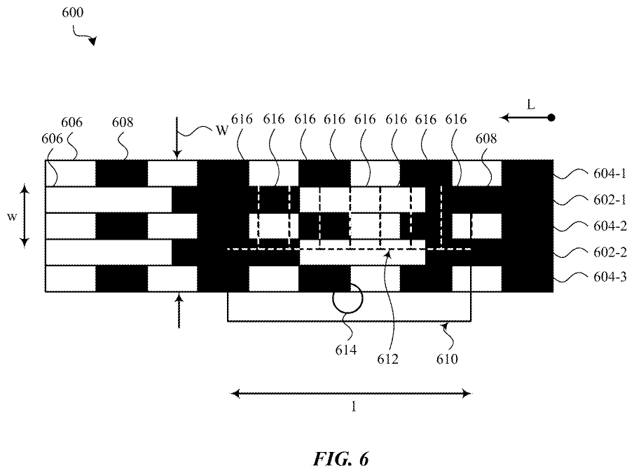

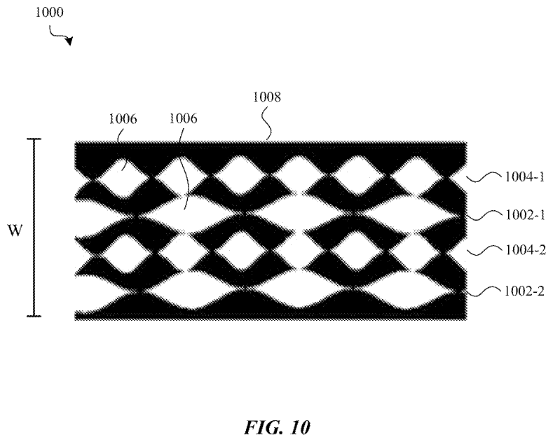

The encoder track 302 may include one or more encoder scales. Each encoder scale may extend along the encoder track 302 (e.g., each encoder scale may extend along, or generally follow, the circular path of the encoder track 302). In some embodiments, the encoder track 302 may include a first encoder scale 308 and a second encoder scale 310. The first encoder scale 308 may have a first period (i.e., a first repetition period) that is different from a second period (i.e., a second repetition period) of the second encoder scale 310. The first and second encoder scales 308, 310 may be warped to follow the circular path of the encoder track 302. More detailed examples of the encoder track 302 and encoder scales 308, 310 are described with reference to FIGS. 6 and 10.

The optical read head 304 may have a field of view 312 that includes a portion (e.g., a portion of the length (L), but also part or all of the width (W)) of the encoder track 302. In embodiments where the encoder track 302 includes more than one encoder scale, the field of view 312 may include portions of each encoder scale of the encoder track 302. For example, when the encoder track 302 includes a first encoder scale 308 and a second encoder scale 310, the field of view 312 may include a first portion of the first encoder scale 308 and a second portion of the second encoder scale 310.

As one or both of the first mechanical component or the second mechanical component is moved relative to the other (e.g., rotated with respect to the other), the relative movement between the first and second mechanical components causes relative movement of the field of view 312 of the optical read head 304 along the encoder track 302. As the field of view 312 moves along the encoder track 302, different portions of the encoder scales 308, 310 move within the field of view 312.

In some embodiments, the optical read head 304 may have multiple pixels 314 (e.g., multiple photodetectors) that extend along a portion (e.g., a portion of the length) of the encoder track 302 defined by the field of view 312. For example, the optical read head 304 may have a single column of pixels (or 1×N array of pixels, where N is an integer ≥2). Alternatively, the optical read head 304 may have a two-dimensional (2D) array of pixels (or M×N array of pixels, where M and N are integers ≥2).

In some embodiments, the optical read head 304 may include one or more optical emitters (e.g., an emitter 316). Each optical emitter of the optical emitter(s) may illuminate part or all of the field of view 312 with a wavelength (or wavelengths) of visible light (e.g., red, blue, or green light) or non-visible light (e.g., infrared (IR) or near-IR light), which visible or non-visible light can be detected by the optical read head 304 after reflecting off of portions of the encoder scale(s) (e.g., encoder scales 308 and 310) included on the encoder track 302. In some embodiments, an emitter may take the form of one or more light-emitting diodes (LEDs) or lasers (e.g., one or more vertical-cavity surface-emitting lasers (VCSELs), edge-emitting lasers (EELs), and so on).

A processor of an electronic device including the optical encoder 300 may be configured to receive an output (e.g., a multiple pixel output) of the optical read head 304 and determine a positional relationship between the first mechanical component and the second mechanical component.

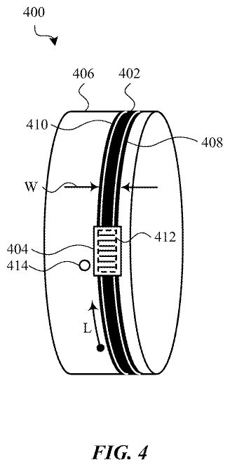

FIG. 4 shows an example perspective view of an optical encoder 400 including an encoder track 402 and an optical read head 404. The encoder track 402 may be disposed around a cylindrical surface 406 and have a cylindrical path. In some embodiments, the cylindrical surface 406 may be a cylindrical surface of a first mechanical component, such as an outer surface of the first mechanical component described with reference to FIG. 1 or a surface of a shaft of the crown described with reference to FIG. 2. The optical read head 404 may be attached to a second mechanical component, such as the second mechanical component described with reference to FIG. 1 or a housing, frame, or other component positioned near the shaft of the crown described with reference to FIG. 2.

The encoder track 402 may include one or more encoder scales, such as a first encoder scale 408 and a second encoder scale 410. The encoder scales 408, 410 may be generally configured as described with reference to FIG. 3, but may extend along, or generally follow, the cylindrical path of the encoder track 402.

The optical read head 404 may have a field of view 412 that includes a portion (e.g., a portion of the circumferential length (L), but also part or all of the width (W)) of the encoder track 402. In embodiments where the encoder track 402 includes more than one encoder scale, the field of view 412 may include portions of each encoder scale of the encoder track 402. For example, when the encoder track 402 includes a first encoder scale 408 and a second encoder scale 410, the field of view 412 may include a first portion of the first encoder scale 408 and a second portion of the second encoder scale 410.

As one or both of the first mechanical component or the second mechanical component is moved relative to the other (e.g., rotated with respect to the other), the relative movement between the first and second mechanical components causes relative movement of the field of view 412 of the optical read head 404 along the encoder track 402. As the field of view 412 moves along the encoder track 402, different portions of the encoder scales 408, 410 move within the field of view 412.

In some embodiments, the optical read head 404 may be configured as described with reference to FIG. 3. In some embodiments, the optical read head 404 may include one or more optical emitters 414. Only one optical emitter is shown in FIG. 4.

A processor of an electronic device including the optical encoder 400 may be configured to receive an output (e.g., a multiple pixel output) of the optical read head 404 and determine a positional relationship between the first mechanical component and the second mechanical component.

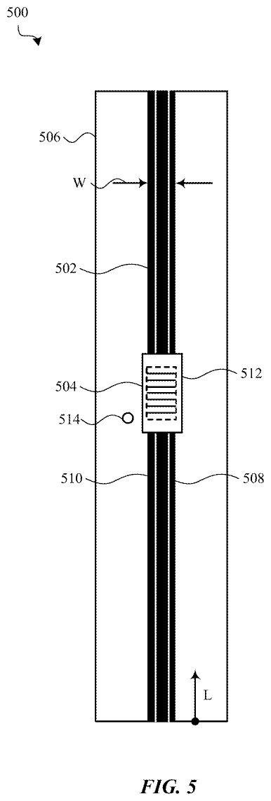

FIG. 5 shows an example plan view of an optical encoder 500 including an encoder track 502 and an optical read head 504. The encoder track 502 is a linear encoder track. In some embodiments, the encoder track 502 may be disposed on a surface 506 of a first mechanical component, such as a longitudinal surface of the shaft of the crown (or a longitudinal surface of the button) described with reference to FIG. 2. The optical read head 504 may be attached to a second mechanical component, such as a housing, frame, or other component positioned near the shaft of the crown (or button) described with reference to FIG. 2.

The encoder track 502 may include one or more encoder scales, such as a first encoder scale 508 and a second encoder scale 510. The encoder scales 508, 510 may be generally configured as described with reference to FIG. 3, but may extend along, or generally follow, the linear path of the encoder track 502.

The optical read head 504 may have a field of view 512 that includes a portion (e.g., a portion of the length (L), but also part or all of the width (W)) of the encoder track 502. In embodiments where the encoder track 502 includes more than one encoder scale, the field of view 512 may include portions of each encoder scale of the encoder track 502. For example, when the encoder track 502 includes a first encoder scale 508 and a second encoder scale 510, the field of view 512 may include a first portion of the first encoder scale 508 and a second portion of the second encoder scale 510.

As one or both of the first mechanical component or the second mechanical component is moved relative to the other (e.g., slid with respect to the other), the relative movement between the first and second mechanical components causes relative movement of the field of view 512 of the optical read head 504 along the encoder track 502. As the field of view 512 moves along the encoder track 502, different portions of the encoder scales 508, 510 move within the field of view 512.

In some embodiments, the optical read head 504 may be configured as described with reference to FIG. 3. In some embodiments, the optical read head 504 may include one or more optical emitters (e.g., an emitter 514).

A processor of an electronic device including the optical encoder 500 may be configured to receive an output (e.g., a multiple pixel output) of the optical read head 504 and determine a positional relationship between the first mechanical component and the second mechanical component.

FIG. 6 shows a first example portion of an encoder track 600. In some embodiments, the portion of the encoder track 600 may be a portion of the encoder track described with reference to FIG. 3, 4, or 5.

The portion of the encoder track 600 includes a first encoder scale 602 and a second encoder scale 604. In some embodiments, and as shown, the first encoder scale 602 may include a first set of repetitions (e.g., repetitions 602-1 and 602-2) and the second encoder scale 604 may include a second set of repetitions (e.g., repetitions 604-1, 604-2, and 604-3). Each encoder scale 602, 604 may include more or fewer repetitions, and in some embodiments may not include any repetitions. When provided, the first and second sets of repetitions may include repetitions interleaved across a width (W) of the encoder track.

In some embodiments, each of the encoder scales 602, 604 may include a sequence of interleaved specular regions 606 (e.g., polished or mirror finish regions) and diffusive (or absorptive) regions 608 (e.g., roughened regions). Alternatively (or additionally) the regions 606 and 608 may have different colors, surfaces with different angular orientations, and so on. By way of example, the regions 606 and 608 are shown to be rectangular (e.g., the regions 606 and 608 may take the form of lines or bars). In other embodiments (e.g., as shown in FIG. 10), the regions 606 and 608 may have other shapes. A specular region 606 and adjacent diffusive region 608, on the same encoder scale (602 or 604), may be referred to herein as a light-dark pair, regardless of whether the adjacent specular and diffusive regions 606, 608 are rectangular or have other shapes.

The specular regions 606 and diffusive regions 608 of a singular encoder scale (602 or 604) may have the same length along the encoder track 600, and the specular regions 606 and diffusive regions 608 of different encoder scales (602 vs 604) may have different lengths along the encoder track 600. In some embodiments, the first encoder scale 602 may have N light-dark pairs, and the second encoder scale 604 may have 2*N−1 (or 2*N+1) light-dark pairs (or periods), where N is an integer ≥1. In other embodiments, the first and second encoder scales 602, 604 may have a different ratio of light-dark pairs.

The first encoder scale 602 may have a first period (i.e., a first repetition period) and the second encoder scale 604 may have a second period (i.e., a second repetition period). In some embodiments, each of the first and second periods may be defined by a combination of a specular region 606 and a diffusive region 608. In some embodiments, the first period may be equal to the length (l) of the field of view 612, and the second period may be about half (e.g., just under or just over half) the length (l) of the field of view 612.

An optical read head 610 may have a field of view 612. The field of view 612 may have a length (l) extending along part of the length of the encoder track 600, and a width (w) extending transverse to the length of the encoder track 600. In some embodiments, the width (w) of the field of view 612 may be less than the width (W) of the encoder track 600. When the width of the field of view 612 is narrower than the width of the encoder track 600, it may be easier to position the field of view 612 on the encoder track 600. Providing repetitions of the first and second encoder scales 602, 604 also makes it easier to position the field of view 612 on the encoder track 600. In some embodiments, the field of view 612 may include only some repetitions (one or more) in the first set of repetitions 602-1, 602-2 and/or some repetitions (one or more) in the second set of repetitions 604-1, 604-2, 604-3.

In some embodiments, the optical read head 610 may sense ambient light that reflects off the specular regions 606 and toward the optical read head 610. In other embodiments, the optical read head 610 may include one or more optical emitters (e.g., an emitter 614) that provide the illumination that reflects off the specular regions 606.

As described with reference to FIGS. 3-5, the optical read head 610 may have multiple pixels 616 (e.g., multiple photodetectors) that extend along a portion of the encoder track 600 (e.g., along a portion of the length of the encoder track 600). For example, the optical read head 610 may have a single column of pixels (or 1×P array of pixels, where P is an integer ≥2). Alternatively, the optical read head 610 may have a two-dimensional (2D) array of pixels (or P×Q array of pixels, where P and Q are integers ≥2). The optical read head 610 may simultaneously read the first encoder scale 602 (or one or more repetitions 602-1, 602-2 thereof) and the second encoder scale 604 (or one or more repetitions 604-1, 604-2, 604-3 thereof).

In some embodiments, the optical read head 610 may include a 1×P array of pixels 616 in which P≥6. By way of example, the optical read head 610 is shown to have eight pixels 616. Each pixel 616 may receive light that reflects off portions of both encoder scales 602, 604. Thus, instead of reading just one encoder scale 602 or 604, the optical read head 610 may read both encoder scales 602, 604 simultaneously, and may generate an output that is a sum (or average) of both encoder scales 602, 604. The multiple pixel instantaneous output of the optical read head 610 may be unique for each position of the optical read head 610 along the encoder track 600, so long as the optical read head is moved more than a threshold distance along the encoder track 600. In some embodiments, the threshold distance may be a fraction of a degree with respect to a center or rotation of the encoder track 600 or optical read head 610.

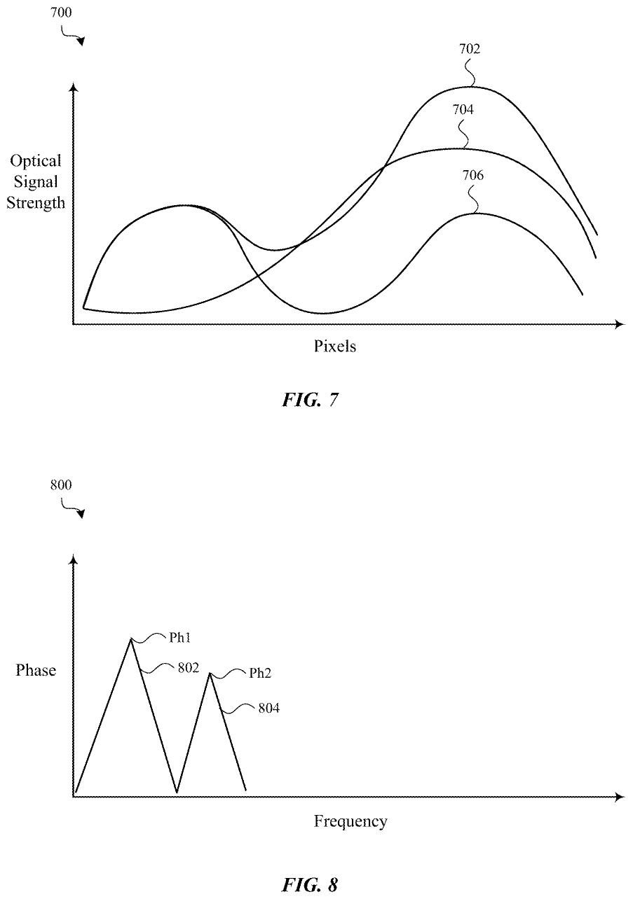

FIG. 7 shows a graph 700 of an example multiple pixel instantaneous output 702 of the optical read head shown in FIG. 6. The output 702 may represent a sum (or average) of the first encoder scale and the second encoder scale, and in some embodiments may be a quasi-sinusoidal output. The x-axis of the graph 700 corresponds to the different pixels of the optical read head, and the y-axis corresponds to an optical signal strength or amount of received light.

Although not an output of the optical read head, the graph 700 also shows the portions of the output 702 contributed by the first encoder scale and the second encoder scale. For example, a sinusoidal portion 704 may be contributed by the first encoder scale, and a sinusoidal portion 706 may be contributed by the second encoder scale. Of note, a phase difference exists between the first and second sinusoidal portions 704, 706, with the phase difference being dependent on the position of the optical read head with respect to the encoder track.

To determine the phase difference, the multiple pixel instantaneous output (or image output) of the optical read head may be transformed to a spatial frequency domain. The transformation may be performed using a fast Fourier transform (FFT) or similar method.

FIG. 8 shows a graph 800 of an FFT of the multiple pixel instantaneous output shown in FIG. 7. The x-axis of the graph 800 corresponds to different frequencies. The y-axis corresponds to a phase. As shown, the graph 800 of the output includes two frequency bins 802, 804 corresponding, respectively, to the two encoder scales. Each frequency bin 802, 804 is associated with a phase (e.g., Ph1 or Ph2). A difference between the two phases may represent a unique position of the optical read head with respect to the encoder track. As such, the difference between the two phases can be mapped to a positional relationship between the optical read head and the encoder track (or to a positional relationship between first and second mechanical components, on which the encoder track is disposed and the optical read head is attached.

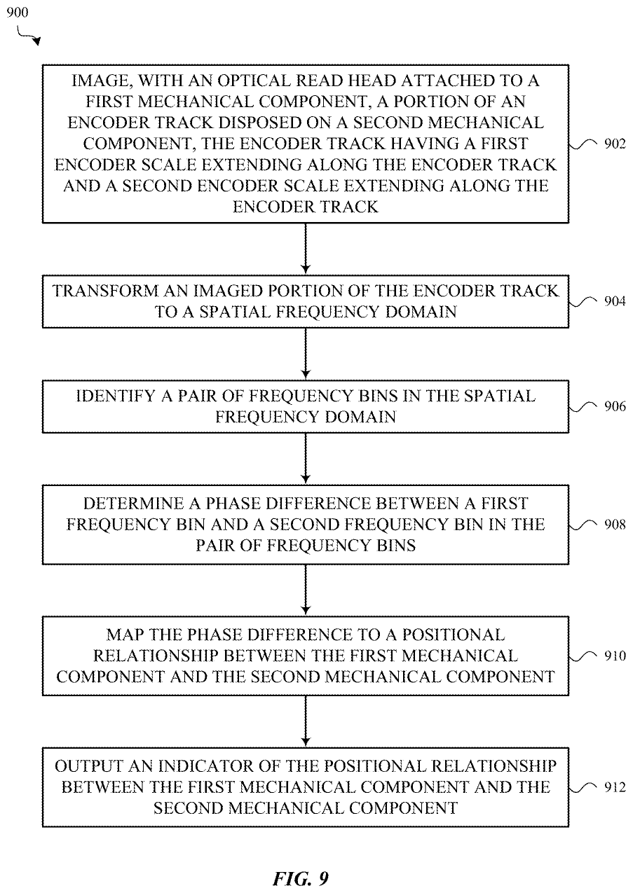

FIG. 9 shows an example method 900 of determining a position of a first mechanical component with respect to a second mechanical component. The method 900 may be performed by, or under the control of, a processor of a device, such as a processor associated with the device shown in FIG. 1, 2, or 11.

At 902, the method 900 may include imaging, with an optical read head attached to the second mechanical component, a portion of an encoder track disposed on the first mechanical component. The encoder track may include a first encoder scale extending along the encoder track and a second encoder scale extending along the encoder track. The imaged portion of the encoder track may include a first portion of the first encoder scale and a second portion of the second encoder scale. In some embodiments, the first and second mechanical components may be the first and second mechanical components described with reference to any of FIG. 1-5 or 11. In some embodiments, the encoder track may be any of the encoder tracks described with reference to FIG. 3-6 or 10.

In some embodiments of the method 900, the first portion of the first encoder scale and the second portion of the second encoder scale may be imaged simultaneously. In other embodiments of the method 900, the first portion of the first encoder scale and the second portion of the second encoder scale may be imaged alternately, at a rate that is much greater than the speed of movement between the optical read head and the encoder track.

At 904, the method 900 may include transforming an imaged portion of the encoder track to a spatial frequency domain. In some embodiments, the transformation may be performed using an FFT or similar method.

At 906, the method 900 may include identifying a pair of frequency bins in the spatial frequency domain.

When the optical read head reads encoder tracks having N and 2*N+1 (or 2*N−1) periods, the information content of the first and second encoder tracks is sufficiently orthogonal in the frequency domain that good separation can be maintained between the frequency bins identified at 906. In other words, because the 2*N+1 (or 2*N−1) period encoder track has a spatial frequency of nearly 2× the fundamental frequency of the N period encoder track, the information content of the first and second encoder tracks is sufficiently orthogonal. Therefore, the phases of the fundamental frequency and second harmonic frequency can be calculated independently, which satisfies the Nonius requirement of two independent phase measurements.

At 908, the method 900 may include determining a phase difference between a first frequency bin and a second frequency bin in the pair of frequency bins.

At 910, the method 900 may include mapping the phase difference to a positional relationship between the first mechanical component and the second mechanical component.

At 912, the method 900 may optionally output an indicator (e.g., a position or an angle) of the positional relationship between the first mechanical component and the second mechanical component. The indicator may enable a user, computer program, or control system to assess the current position between the first and second mechanical components and take further action, if necessary.

In some embodiments of the method 900, at least the first portion of the first encoder scale and the second portion of the second encoder scale may be illuminated during the imaging. In some embodiments, additional portions of the encoder scales (e.g., outside the field of view of the optical read head) may be illuminated. In some embodiments, the same or different portions of the encoder track may be illuminated by different wavelengths of visible or non-visible light—simultaneously or alternately.

FIG. 10 shows a second example portion of an encoder track 1000. In some embodiments, the portion of the encoder track 1000 may be a portion of the encoder track described with reference to FIG. 3, 4, or 5.

The portion of the encoder track 1000 includes a first encoder scale 1002 and a second encoder scale 1004. In some embodiments, and as shown, the first encoder scale 1002 may include a first set of repetitions (e.g., repetitions 1002-1 and 1002-2) and the second encoder scale 1004 may include a second set of repetitions (e.g., repetitions 1004-1 and 1004-2). Each encoder scale 1002, 1004 may include more or fewer repetitions, and in some embodiments may not include any repetitions. When provided, the first and second sets of repetitions may include repetitions interleaved across a width (W) of the encoder track.

In some embodiments, each of the encoder scales 1002, 1004 may include a series of specular regions 1006 (e.g., polished or mirror finish regions) surrounded by diffusive (or absorptive) regions 1008 (e.g., roughened regions). Alternatively (or additionally) the regions 1006 and 1008 may have different colors, surfaces with different angular orientations, and so on. As shown, each of the specular regions 1006 may have a 2D sinusoid shape (i.e., a filled sinusoid shape, or shape defined by two stacked sinusoids that are 180 degrees out of phase). Alternatively, the regions 1006 may have different shapes, such as different sinusoidal shapes. In comparison to the first encoder scale 1002, the second encoder scale 1004 may have 2D sinusoid shapes with shorter lengths along the length of the encoder track 1000 (i.e., the first encoder scale 1002 may have a first set of 2D sinusoids, in which each sinusoid has a first length along the encoder track 1000, and the second encoder scale 1004 may have a second set of 2D sinusoids, in which each sinusoid has a second length along the encoder track 1000).

The encoder track 1000 may be read similarly to the encoder track described with reference to FIG. 6. However, the 2D sinusoid shapes of the first and second encoder scales 1002, 1004 may provide less noise in the spatial frequency content of an optical read head's output. The 2D sinusoid shapes may also enable an increase in encoder resolution, from 2-8 bits (typical of rectangular specular regions) to 14 bits.

In some alternative embodiments of the encoder tracks described herein, the first and second encoder scales may be defined by lines that cross-fade into each other with variable darkness (diffusiveness or absorptiveness) or opacity (specularity). In some embodiments, the 2D sinusoid regions described with reference to FIG. 10 may be replaced with triangular, trapezoidal, chevron, or circular-shaped regions.

In some alternative embodiments of the encoder tracks described herein, an encoder track may have a first encoder scale with a set of specular regions that reflect a first wavelength of light, and a second encoder scale with a set of specular regions that reflect a second wavelength of light. In such an encoder, the first and second encoder scales may be alternately illuminated with the first or second wavelength of light, and an optical encoder head may alternately read the first and second encoder scales (or a color-resolving optical read head may simultaneously read both encoder scales). In some embodiments, the encoder scales that reflect different wavelengths of light may be overlapped.

In some alternative embodiments of the encoder tracks described herein, a third, fourth, or additional encoder scale may be added. Measurement of a third phase of a third encoder scale (corresponding to a third harmonic (e.g., 3N±2)) or a fourth phase of a fourth encoder scale (corresponding to a fourth harmonic (e.g., 4N±3) can be helpful when the encoder scales are long (e.g., when the encoder scale of N periods has more than approximately 100 periods). However, the addition of encoder scales may require an increase in resolution of the optical read head, to accommodate the greater number of independent frequencies.

In some alternative embodiments, an optical encoder configured as described herein may have more than one optical read head. At least one of the optical read heads (or each of the optical read heads) may read an encoder track associated with two or more encoder scales.

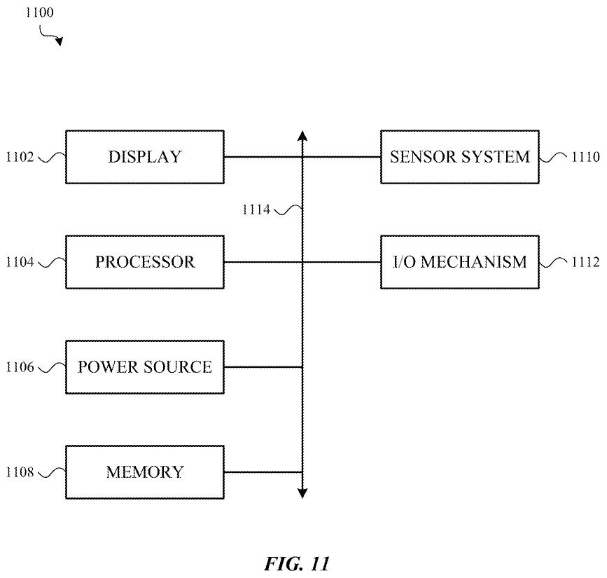

FIG. 11 shows a sample electrical block diagram of an electronic device 1100, which electronic device may in some embodiments be the device described with reference to FIG. 1 or 2, or a device including the optical encoder described with reference to FIG. 3, 4, or 5. The electronic device 1100 may optionally include an electronic display 1102 (e.g., a light-emitting display), a processor 1104, a power source 1106, a memory 1108 or storage device, a sensor system 1110, and/or an input/output (I/O) mechanism 1112 (e.g., an input/output device, input/output port, or haptic input/output interface). The processor 1104 may control some or all of the operations of the electronic device 1100. The processor 1104 may communicate, either directly or indirectly, with some or all of the other components of the electronic device 1100. For example, a system bus or other communication mechanism 1114 can provide communication between the electronic display 1102, the processor 1104, the power source 1106, the memory 1108, the sensor system 1110, and the I/O mechanism 1112.

The processor 1104 may be implemented as any electronic device capable of processing, receiving, or transmitting data or instructions, whether such data or instructions is in the form of software or firmware or otherwise encoded. For example, the processor 1104 may include a microprocessor, a central processing unit (CPU), an application-specific integrated circuit (ASIC), a digital signal processor (DSP), a controller, or a combination of such devices. As described herein, the term “processor” is meant to encompass a single processor or processing unit, multiple processors, multiple processing units, or other suitably configured computing element or elements. In some embodiments, the processor 1104 may provide part or all of the processing system or processor described herein.

It should be noted that the components of the electronic device 1100 can be controlled by multiple processors. For example, select components of the electronic device 1100 (e.g., the sensor system 1110) may be controlled by a first processor and other components of the electronic device 1100 (e.g., the electronic display 1102) may be controlled by a second processor, where the first and second processors may or may not be in communication with each other.

The power source 1106 can be implemented with any device capable of providing energy to the electronic device 1100. For example, the power source 1106 may include one or more batteries or rechargeable batteries. Additionally or alternatively, the power source 1106 may include a power connector or power cord that connects the electronic device 1100 to another power source, such as a wall outlet.

The memory 1108 may store electronic data that can be used by the electronic device 1100. For example, the memory 1108 may store electrical data or content such as, for example, audio and video files, documents and applications, device settings and user preferences, timing signals, control signals, instructions, and/or data structures or databases. The memory 1108 may include any type of memory. By way of example only, the memory 1108 may include random access memory, read-only memory, Flash memory, removable memory, other types of storage elements, or combinations of such memory types.

The electronic device 1100 may also include one or more sensor systems 1110 positioned almost anywhere on the electronic device 1100. In some embodiments, the sensor systems 1110 may include one or more optical encoders, positioned and/or configured as described herein. The sensor system(s) 1110 may be configured to sense one or more type of parameters, such as but not limited to, position; vibration; light; touch; force; heat; movement; relative motion; biometric data (e.g., biological parameters) of a user; air quality; proximity; connectedness; surface quality; and so on. By way of example, the sensor system(s) 1110 may include a position sensor (e.g., an optical encoder), a heat sensor, a light or optical sensor, an accelerometer, a pressure transducer, a gyroscope, a magnetometer, a health monitoring sensor, and an air quality sensor, and so on. Additionally, the one or more sensor systems 1110 may utilize any suitable sensing technology, including, but not limited to, optical, interferometric, magnetic, capacitive, ultrasonic, resistive, acoustic, piezoelectric, or thermal technologies.

The I/O mechanism 1112 may transmit or receive data from a user or another electronic device. The I/O mechanism 1112 may include the electronic display 1102, a touch sensing input surface, a crown, one or more buttons (e.g., a graphical user interface “home” button), one or more cameras (including an under-display camera), one or more microphones or speakers, one or more ports such as a microphone port, and/or a keyboard. Additionally or alternatively, the I/O mechanism 1112 may transmit electronic signals via a communications interface, such as a wireless, wired, and/or optical communications interface. Examples of wireless and wired communications interfaces include, but are not limited to, cellular and Wi-Fi communications interfaces.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. An electronic device, comprising:
a first mechanical component and a second mechanical component, the first mechanical component or the second mechanical component operable to be moved to change a positional relationship between the first mechanical component and the second mechanical component;
an encoder track on the first mechanical component, the encoder track including,
a first encoder scale extending along the encoder track; and
a second encoder scale extending along the encoder track, the first encoder scale having a first period different from a second period of the second encoder scale; and
an optical read head attached to the second mechanical component and having,
multiple pixels extending along a portion of the encoder track; and
a field of view including a first portion of the first encoder scale and a second portion of the second encoder scale; wherein,
relative movement between the first and second mechanical components causes relative movement of the field of view of the optical read head along the encoder track.

2. The electronic device of claim 1, further comprising:
a processor configured to, for the positional relationship between the first mechanical component and the second mechanical component,
transform a multiple pixel output of the optical read head to a spatial frequency domain;
identify a pair of frequency bins in the spatial frequency domain;
determine a phase difference between a first frequency bin and a second frequency bin in the pair of frequency bins;
map the phase difference to the positional relationship between the first mechanical component and the second mechanical component; and
output an indicator of the positional relationship between the first mechanical component and the second mechanical component.

3. The electronic device of claim 1, wherein:
the first encoder scale comprises a first set of repetitions;
the second encoder scale comprises a second set of repetitions; and
the first set of repetitions and the second set of repetitions include repetitions that are interleaved across a width of the encoder track.

4. The electronic device of claim 3, wherein the field of view of the optical read head includes only some of the first set of repetitions or some of the second set of repetitions.

5. The electronic device of claim 1, wherein:
the first encoder scale includes specular regions having a first two-dimensional (2D) sinusoid shape, the first 2D sinusoid shape having a first length along a length of the encoder track; and
the second encoder scale includes specular regions having a second 2D sinusoid shape, the second 2D sinusoid shape having a second length along the length of the encoder track, the second length different from the first length.

6. The electronic device of claim 1, wherein:
the field of view has a length extending along part of a length of the encoder track;
the first period is equal to the length of the field of view; and
the second period is equal to about half the length of the field of view.

7. The electronic device of claim 1, wherein the multiple pixels of the optical read head extend in a single column along the encoder track.

8. The electronic device of claim 1, wherein each of the first encoder scale and the second encoder scale comprises interleaved specular regions and diffusive or absorptive regions.

9. The electronic device of claim 1, wherein:
the first encoder scale comprises a set of specular regions that reflects a first wavelength of light; and
the second encoder scale comprises a set of specular regions that reflects a second wavelength of light.

10. The electronic device of claim 1, wherein:
the encoder track is disposed on a planar surface of the first mechanical component and has a circular path; and
the first encoder scale and the second encoder scale are warped to follow the circular path.

11. The electronic device of claim 1, wherein the encoder track is disposed around a cylindrical surface of the first mechanical component.

12. The electronic device of claim 1, wherein the first mechanical component and the second mechanical component are operable to be moved linearly to change the positional relationship between the first mechanical component and the second mechanical component.

13. The electronic device of claim 1, wherein:
the first mechanical component and the second mechanical component are connected at a rotary joint; and
the first mechanical component or the second mechanical component is operable to be rotated with respect to the other of the first mechanical component or the second mechanical component, to change the positional relationship between the first mechanical component and the second mechanical component.

14. A method of determining a position of a first mechanical component with respect to a second mechanical component, comprising:
imaging, with an optical read head attached to the second mechanical component, a portion of an encoder track disposed on the first mechanical component, the encoder track having a first encoder scale extending along the encoder track and a second encoder scale extending along the encoder track, and the imaged portion of the encoder track including a first portion of the first encoder scale and a second portion of the second encoder scale;
transforming the imaged portion of the encoder track to a spatial frequency domain;
identifying a pair of frequency bins in the spatial frequency domain;
determining a phase difference between a first frequency bin and a second frequency bin in the pair of frequency bins; and
mapping the phase difference to a positional relationship between the first mechanical component and the second mechanical component.

15. The method of claim 14, wherein the imaging comprises:
simultaneously imaging the first portion of the first encoder scale and the second portion of the second encoder scale.

16. The method of claim 14, further comprising:
illuminating at least the first portion of the first encoder scale and the second portion of the second encoder scale during the imaging.

17. An electronic device, comprising:
a first mechanical component;
a second mechanical component, movably coupled to the first mechanical component;
an encoder track on the first mechanical component, the encoder track including an encoder scale comprising a set of two-dimensional (2D) sinusoids extending along a length of the encoder track; and
an optical read head attached to the second mechanical component; wherein,
the optical read head has a field of view including a portion of the encoder scale; and
relative movement between the first and second mechanical components causes relative movement of the field of view of the optical read head along the encoder track.

18. The electronic device of claim 17, wherein the first and second mechanical components define at least part of a robotic arm.

19. The electronic device of claim 17, wherein:
the encoder scale is a first encoder scale and the set of 2D sinusoids is a first set of 2D sinusoids;
each 2D sinusoid in the first set of 2D sinusoids has a first length along the length of the encoder track;
the encoder track further has a second encoder scale extending along the length of the encoder track, the second encoder scale comprising a second set of 2D sinusoids;
each 2D sinusoid in the second set of 2D sinusoids has a second length along the length of the encoder track; and
the field of view of the optical read head further includes a portion of the second encoder scale.

20. The electronic device of claim 19, wherein:
the encoder track is disposed on a planar surface and has a circular path; and
the encoder scale is warped to follow the circular path.
